(19) United States
(12) Patent Application Publication
(10) Pub. No.: US 2018/0262467 A1
(43) Pub. Date: Sep. 13, 2018

(54) CLOUD-BASED DDOS MITIGATION

(71) Applicant: AT&T Intellectual Property I, L.P., Atlanta, GA (US)

(72) Inventors: Thusitha JAYAWARDENA, Holmdel, NJ (US); John LIEFERT, Matawan, NJ (US); Christopher VAN WART, Ocean, NJ (US)

(73) Assignee: AT&T Intellectual Property I, L.P.

(21) Appl. No.: 15/453,476

(22) Filed: Mar. 8, 2017

(51) Int. Cl. H04L 29/06; H04L 29/12

(52) U.S. Cl. CPC H04L 63/0254; H04L 61/1511; H04L 63/1425; H04L 63/1458; H04L 63/0281; H04L 61/2503

(57) ABSTRACT

Systems and methods provide mitigation for denial of service attacks against servers open to the Internet by preventing delivery of malicious traffic to servers using network gateways.

### TECHNICAL FIELD

The disclosures herein generally relate to network technologies. In particular, the disclosures relate to mitigating the effects of distributed attacks against servers in networks.

### BACKGROUND

A variety of techniques exist for limiting the impact of malicious traffic against network elements and services. However, particular network elements and/or services may be protectable in particular manners not available to most elements and/or services. Cloud-based techniques for mitigating the effects of malicious traffic are lacking in development due to the existing performance gap between cloud-based services implemented on common off-the-shelf (COTS) hardware and custom hardware-based services. However, such cloud-based techniques may be employed to provide improved protection when used for protecting particular network elements or services.

### SUMMARY

An embodiment includes a network gateway configured to receive inbound and outbound communication associated with a server. The network gateway comprises a logging module configured to log an outbound communication through the network gateway from the server as an entry in a traffic state table and a traffic interrogation module configured to interrogate an inbound communication for the server against the traffic state table. If the inbound communication corresponds to the entry in the traffic state table for the outbound communication, the network gateway is configured to transmit the inbound communication to the server and remove the entry from the traffic state table. If the inbound communication does not correspond to the entry in the traffic state table for the outbound communication, the network gateway is configured to drop the inbound communication.

In another embodiment, a method can comprise receiving an inbound communication for a server at a network gateway and interrogating the inbound communication against a traffic state table at the network gateway. If the inbound communication corresponds to an entry in the traffic state table, the inbound communication is transmitted to the server and the entry is removed from the traffic state table. If the inbound communication does not correspond to the entry in the traffic state table, the inbound communication is dropped at the network gateway.

In still another embodiment, a system can comprise a means for creating an entry in a traffic state table based on an outbound communication from a server and a means for interrogating an inbound communication for the server at a network gateway, the inbound communication interrogated against the traffic state table. If the inbound communication corresponds to an entry in the traffic state table, the inbound communication is transmitted to the server and the entry is removed from the traffic state table. If the inbound communication does not correspond to the entry in the traffic state table for the outbound communication, the inbound communication is dropped at the network gateway.

These and other embodiments are described in greater detail elsewhere herein. In some of the following descriptions a particular embodiment and its details are used to illustrate aspects of the disclosure. The applicability of the method is not limited to the particular embodiments described herein.

### BRIEF DESCRIPTION OF THE DRAWINGS

To better understand and appreciate aspects of the disclosure, refer to the following detailed description in connection with the accompanying drawings:

FIG. 1A shows a representation of an example cloud-based platform for an embodiment of the system and provides details on implementation of aspects herein;

FIG. 1B shows an example network architecture for implementing attack mitigation techniques as disclosed herein;

FIG. 2 an example traffic management module as disclosed herein;

FIG. 3 illustrates an methodology for mitigating attacks as disclosed herein;

### DETAILED DESCRIPTION

The subject innovation generally concerns mitigating attacks in network environments. One such attack mitigated by these disclosures is a Denial of Service (DoS) attack, or Distributed Denial of Service (DDoS) attacks which are DoS attacks leveraging a plurality of distributed devices or nodes to multiply the attack's effects. DDoS attacks seek to flood a targeted system with multiple systems transmitting traffic to the targeted system, the result of which is degraded performance of the targeted system or its total unavailability. If the targeted system is, for example, a domain name system (DNS) server, a DDoS attack can effectively render services dependent on DNS unavailable to the customers of such services.

By way of background, DNS is a critical resource for network services. The primary use of DNS is to perform name resolution. In this regard, DNS translates human readable names into internet protocol (IP) addresses. For example, www.att.com may be translated to an IP address such as 104.90.58.248. DNS is a distributed service, consisting first of several top level domains (tld) such as .com, .org, .gov, .edu, and others. Within each tld, subdomains are delegated to different entities. For example, within the .com tld, the att.com subdomain is delegated to AT&T. As the delegate, AT&T maintains the authoritative DNS servers for the subdomain att.com. When a user on the Internet needs to reach a server such as www.att.com that person's local DNS resolver initiates a DNS query for the IP address of www.att.com. That query is (eventually) answered with a response from the authoritative DNS server for subdomain att.com. These answers can be cached in intermediate DNS servers so that the same query can be answered quickly without having to consult authoritative servers.

Types of DNS servers include iterative and recursive DNS servers. Iterative DNS servers respond to queries with answers they have locally. If the answer is not found locally, they can refer the querying DNS resolver to other DNS servers. Recursive DNS servers also respond to queries with answers they may have locally, but if the answer is not found locally, they query other DNS servers on behalf of the DNS resolver until an answer is found. Also, DNS queries can be either recursive or non-recursive. When a recursive DNS server receives a recursive query it will query other DNS servers if it does not have the answer locally. However, an iterative DNS server can be configured so that it will drop recursive queries silently when the answer to the query is not available locally.

As used herein, a “carrier” may be an Internet service provider or a cellular network service provider, or an entity that provides both these services, as well as, for example, a provider of other services over an IP network infrastructure. The DNS servers of a carrier can be divided into two classes: Authoritative servers that service queries about entities belonging to the carrier and recursive DNS servers that serve customers of the carrier. Separation of these two types of servers is a “best practice.” Furthermore, it is a best practice to make the authoritative servers non-recursive and configure them to drop received recursive queries.

Valid DNS queries to the non-recursive authoritative servers can be queries about systems which belong to the carrier's domain Valid queries to these authoritative servers can originate from any entity in the Internet. Since the authoritative servers have the information about its own domain locally they do not need to query other DNS servers. As a result there should be no DNS responses from external networks destined to the carrier's authoritative servers when the best practice of separating authoritative servers from recursive servers is implemented.

Customers of a carrier will originate DNS queries about systems both within and outside the carrier's domain. Thus, the carrier's recursive DNS servers query external authoritative DNS servers in other domains to resolve names of systems belonging to other domains. Therefore, these recursive servers will send queries to outside DNS servers and will receive responses to these queries.

The authoritative servers can be protected by sending traffic destined to them through a DNS-aware firewall and dropping non-DNS traffic, DNS responses, invalid DNS queries and valid DNS queries about systems outside of the carrier's domain, i.e. allowing valid DNS queries about systems within the carrier's domain to reach the authoritative servers but not other traffic. Such DNS-aware firewalls can be placed at the edge of the carrier network. Furthermore, using cloud computing techniques multiple such DNS firewalls can be spun up or spun down to match varying demand.

Reference is made to documents providing further information: 1) DNS Amplification Attacks|US-CERT, available at https://www.us-cert.gov/ncas/alerts/TA13-088A (last viewed Feb. 28, 2017) (“CERT Alert”); 2) Lucian Constantin, Report: Open DNS resolvers increasingly abused to amplify DDoS attacks, available at http://www.pcworld.com/article/2013109/report-open-dns-resolvers-increasingly-abused-to-amplify-ddos-attacks.html (last viewed Feb. 28, 2017) (“DNS Resolvers Report”); and Bloom filter—Wikipedia, available at https://en.wikipedia.org/wiki/Bloom_filter (last viewed Feb. 28, 2017) (“Bloom Filter Description”).

To illustrate the proposed techniques, the drawings and specification describe systems and methods to protect a carrier's recursive DNS servers. However, such techniques may be employed with other interoperable network elements elements. Because the recursive DNS servers serving the carrier's customers need to receive responses from the Internet, protecting them from DDoS attacks or other malicious inbound traffic can be present significant difficulties. Some of the most devastating DDoS attacks seen on the Internet are DNS reflection and DNS amplification attacks. See, e.g., CERT Alert and DNS Resolvers Report. These attacks make use of open DNS resolvers. (Open resolvers will accept queries from any entity in the Internet. See, e.g., DNS Resolvers.) The attackers send a large number of queries with a spoofed source IP address to open resolvers. The spoofed IP address is that of the victim system. When the attack is directed at a carrier's DNS system, the spoofed IP address is set to the carrier's DNS IP address. The open resolvers will query various DNS servers by forwarding the queries sent by the attacker. Since the source IP address of the queries remains the spoofed address, the responses from the DNS servers will be sent to the victim. This is a reflected DNS attack. Certain types of DNS queries elicit large response packets. If the reflected DNS attack is based on such queries, the attack is known as a DNS amplification attack. See, e.g., CERT Alert.

DoS and DDoS attacks can degrade or make unavailable the DNS service by exhausting network capacity and other resources such as central processing unit (CPU) cycles or system memory (or both), by sending various types of traffic (DNS queries, DNS responses, Internet Control Message Protocol (ICMP) traffic, Transmission Control Protocol (TCP) synchronize message (SYN) floods, and others) to the IP addresses of the target DNS servers. Even to simply discard the non-DNS and invalid DNS traffic, the target server expends memory, CPU cycles, and network bandwidth.

Several terms are used to describe the travel of a communication. The terms “upstream,” “downstream,” “in front of,” or “behind” are some such terms. These terms may be relative to the communication depending on the origin and intended address for delivery of the communication, or may describe the orientation of a network element with regard to traffic. One example of an element that is “upstream” of another element is if the element is closer to the originator of a communication than the other element, and one example of an element that is “downstream” of another element is if the element is further from the originator of the communication than the other element. One example of an element that is “behind” another element is when another element intervenes between it and originators of at least a portion of traffic (e.g., traffic outside the recipient device domain; traffic from a particular domain; certain types of traffic; all traffic). On the other hand, one example of an element that is “in front of” another element is an element that is positioned between at least a portion of traffic and the other element.

One example of a “module” used herein can be hardware, software, or a combination thereof, and can be implemented by or stored on circuits, processors, or non-transitory computer readable media.

“Traffic addressing information” or similar terminology as used herein includes at least one of a port number and an internet protocol address, but may include additional information related to the communication transmission. “Communication state information” or similar terminology is information about the state of a communication, which can include traffic addressing information, and also include information about its Internet Protocol and higher layer information such as TCP or user datagram protocol (UDP) port numbers, TCP initial sequence numbers, DNS transaction ID, et cetera.

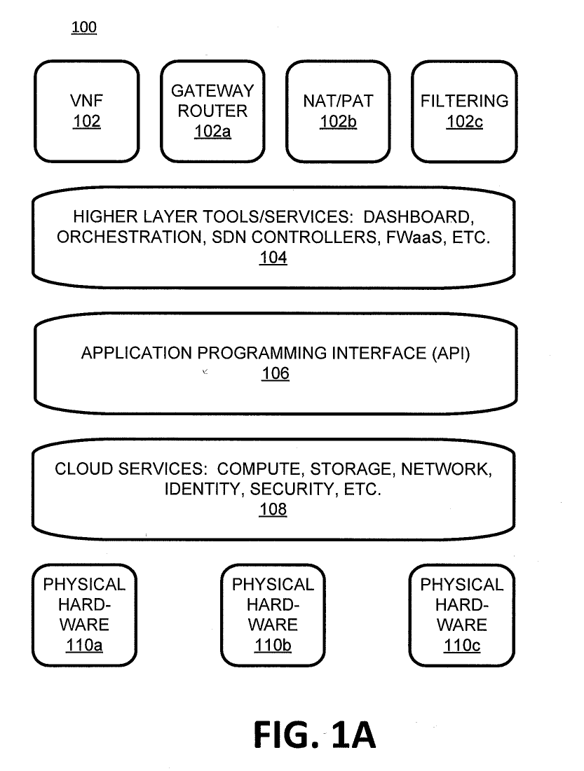

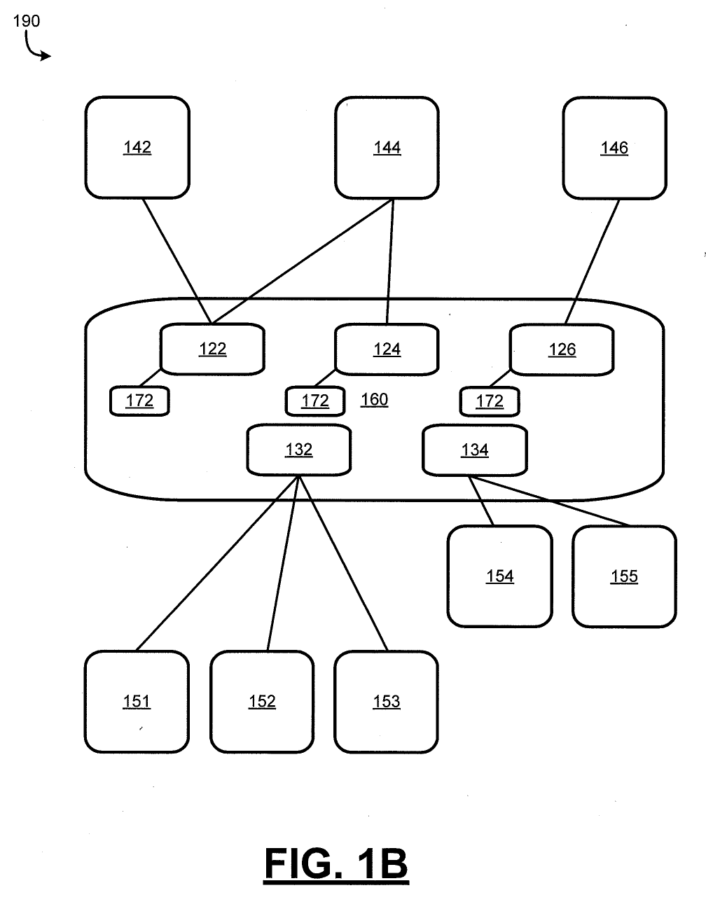

Turning to the drawings, FIG. 1A is a representation of an example cloud computing platform 100 showing techniques for implementing aspects disclosed herein. Cloud computing platform 100 may comprise a cloud computing platform with a software-defined network (SDN).

The physical hardware of the cloud platform may comprise multiple COTS servers 110a, 110b, 110c.

The cloud computing nodes, controller nodes, networking nodes, etc. which provide the compute, storage, networking, identity, security and other cloud services 108 are implemented on the COTS hardware 110a, 110b, 110c. In embodiments, other, non-COTS hardware may be utilized without departing from the scope or spirit of the innovation.

Also, an Application Programming Interface (API) 106 into the cloud services is available for constructing higher layer services.

Higher layer services 104 such as SDN controllers, Firewall as a Service, Dashboards, and Orchestration tools etc. are implemented using the API 106.

Virtual Network Function 102 may use the higher layer services 104, as well as, the API 106 to create virtual network function modules that implement various network functions. Three such network functions gateway routing (102a), Network Address/Port Address Translation (102b), and filtering (102c) are depicted in FIG. 1A.

The cloud computing platform 100 in FIG. 1A can be used to implement distributed virtual network functions on all or some nodes of a carrier network. This can be achieved by one or many replicas of the cloud computing platform.

FIG. 1B illustrates an example system 190 for implementing attack mitigation modules for protecting against DoS attacks. System 190 includes carrier network 160, which communicates with entities outside carrier network 160 using network gateways 122, 124, and 126 and edge nodes 132 and 134. Network gateways 122, 124, and 126 communicate with external carrier networks 142, 144, and 146, while edge nodes 132 and 134 communicate with the carrier's customer networks 151, 152, 153, 154, and 155. In embodiments, network gateways 122, 124, and 126 can be internet gateway routers within a carrier network, and/or edge nodes 132 and 134 can be provider edge routers within a carrier network. While FIG. 1B shows particular numbers and connections between various elements for purposes of explanation, any number of any element can be provided in alternative configurations (e.g., greater or smaller number of elements, greater or smaller number of connections, differing connections) without departing from the scope or spirit of the innovation.

In an example embodiment, both network gateways 122, 124, 126 and edge nodes 132 and 134 may be virtual network functions (VNFs). In another example embodiment, network gateways 122, 124, and 126 may be VNFs while other elements are not. The network gateway VNF may combine DNS, NAT/PAT, routing, and firewall functions. In an embodiment, an orchestration module 212 may configure each network gateway VNF 122, 124,126 to use a separate one of NAT/PAT pools 172, 174, 176. In parallel, the orchestration module 212 may configure the corresponding routing VNF on each gateway 122, 124, 126 to announce the corresponding NAT pool to the external carrier networks 142, 144, and 146 via routing protocols. Furthermore, the orchestration/management module configures the DNS VNF to use the NAT/PAT VNF for outgoing DNS queries to outside external carrier networks 142, 144, and 146 so that the source IP addresses of DNS queries are mapped to an IP address from the NAT/PAT pools. (These are DNS queries issued by the carrier's recursive DNS servers on behalf of its customers.) Since the NAT pool is also announced by the corresponding routing VNF, the returning DNS responses will arrive at the correct network gateway VNF where the destination IF address will be mapped back to that of the recursive DNS servers of the carrier. The NAT/PAT pools and the corresponding routing announcements can be periodically changed using orchestration module 212 or another management module.

Any traffic destined to the carrier's recursive DNS servers that arrive at the gateway VNF that does not have a corresponding NAT/PAT entry will be dropped. By preventing non-matched traffic from proceeding through any of network gateways 122, 124, and 126 to a DNS server, it becomes overwhelmingly more difficult and complex to direct malicious traffic to the DNS server, substantially preventing widespread denial of service attack traffic. In order to reach the carrier's recursive servers, the incoming DNS responses need to match both the IP address and the UDP port contained in the NAT/PAT translation table. If the attack is a DNS reflection or amplification attack, the amount of attack traffic that may match both the IP address and the port would be orders of magnitude less compared to when there is no matching of port numbers.

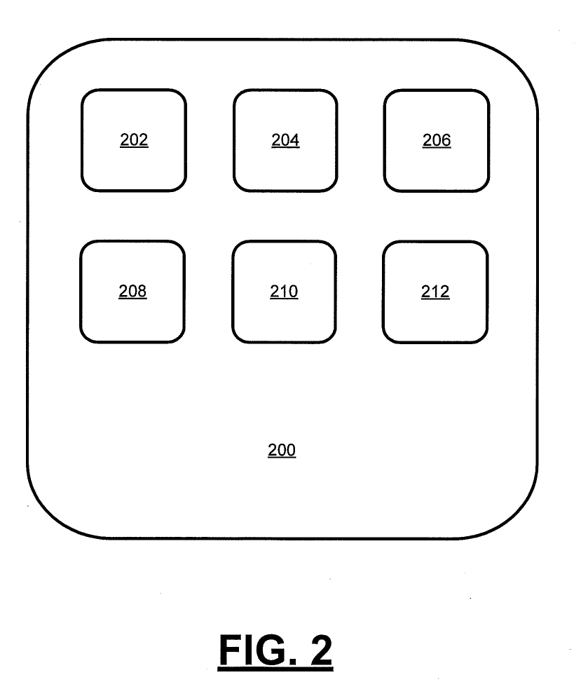

In this regard, FIG. 2 illustrates a traffic management module 200 which can be implemented on one or more of network gateways 122, 124, and 126. Traffic management module 200 as illustrated includes a logging module 202, a monitor module 204, a traffic interrogation module 206, an outbound translation module 208, inbound translation module 210, and an orchestration module 212. While traffic management module 200 is shown with these elements for ease of explaining a variety of embodiments, alternative embodiments may exclude modules shown, include additional modules, include multiples of a module shown in the singular, or otherwise deviate from the illustrated embodiment without departing from the scope or spirit of the innovation.

As discussed, traffic management module 200 exists in, on, or associated with a network gateway in front of a server. Traffic management module 200 serves to screen traffic destined for the server downstream, preventing its flooding in the event of malicious traffic. This is achieved by ensuring transmissions to the server correspond to queries originated by the server.

Traffic management module 200 includes logging module 202 which logs an outbound communication through the network gateway from the server as an entry in a traffic state table. For each communication, the traffic state table can include originator IP address and port number. In further embodiments, recipient information and other details (header information, timestamp, additional metadata, transmission content, et cetera) can also be logged in the traffic state table. This allows incoming traffic to be matched to expected traffic before proceeding to the server.

Traffic management module 200 includes monitor module 204 that monitors an inbound communication for the server through the network gateway. While other traffic may pass through traffic management module 200, communications addressed to the server can be identified to determine whether they correspond to an entry in the traffic state table

Traffic interrogation module 206 of traffic management module 200 interrogates the inbound communication against the traffic state table. Information associated with the inbound communication, such as addressing or other data, is compared to data in the traffic state table. If the inbound communication corresponds to the entry in the traffic state table for the outbound communication, the inbound communication is transmitted to the server and the entry is removed from the traffic state table. Removal of the entry can include, but is not limited to, deletion of the entry, movement of the entry to an inactive table, updating the entry to indicate completion, or performing other actions which present the entry from being reused in conjunction with other inbound traffic. Determination on whether the inbound communication corresponds to the entry in the traffic state table can be based on an exact match of one or more fields, or refer to information which is related to or derivable from (while not identical to) a field of the entry such as a bloom filter. Alternatively, if the inbound communication does not correspond to the entry in the traffic state table for the outbound communication, the inbound communication is dropped at the network gateway.

Traffic management module 200 may further include an outbound translation module 208 and an inbound translation module 210. By varying the addressing information associated with a server (such as a recursive DNS server), no single address range will be apparent to external entities downstream of the network gateway. This increases the difficulty of targeting the server, and allows additional techniques for distinguishing similar communications because different recipient addresses, ports, et cetera can be associated with each query response originating at multiple servers.

In this manner, outbound translation module 208 receives a query from the server and converts or translates the outbound traffic source addressing of the outbound communication to translated traffic source addressing. The outbound translation module can change, e.g., an internet protocol address and a port number of the outbound traffic addressing. The values for translated addressing can be selected from pools for the respective fields being converted, such as an IP address pool and a port number pool. Alternatively or complementarily, the converted values can be selected from ranges. Constraints of the pools and ranges for particular embodiments are described in further detail below. After the outbound traffic communication module 208 has completed its processing, the converted traffic addressing is included in the traffic state table. Then the query is passed onward from the network gateway to its intended recipient.

When the query response (an inbound communication) is routed to the addressing which the external network believes originated the query—the converted traffic addressing—the response arrives at the network gateway. The response can be interrogated against the state table in its current form, or converted by inbound translation module 210 to correspond to the original, unconverted outbound traffic addressing for routing, before or after comparison to the state table. Translation or conversion can involve actual transformation and overwriting of data, or preservation of both (e.g., in the traffic state table) to allow for recognition of converted values while routing according to original values. As the traffic state table may retain both converted and unconverted addressing information, inbound translation module 210 is not necessary in every embodiment.

In embodiments, outbound translation module 208 and inbound translation module 210 can utilize Network Address Translation (NAT) and/or Port Address Translation (PAT). Where NAT and/or PAT is used, address or number pools can be public or modified as private. Other techniques can also be employed without departing from the scope or spirit of the information.

As suggested above, pools or ranges of IP addresses, port numbers, or other convertible information can be coordinated. This can be done to avoid conflicts in environments where several network gateways handle traffic for one or more servers. Accordingly, traffic management module 200 can include orchestration module 212, which assigns outbound traffic addressing ranges for use by the outbound translation module that are distinct from those assigned to a second outbound translation module of a second orchestration module, the second orchestration module of a second network gateway. This can be done in a pre-planned manner or on-the-fly. Pre-planned techniques can include arranging pools with continuous or discontinuous values, assigning ranges which do not overlap, et cetera. On-the-fly techniques allow communication between orchestration module 212 and other orchestration modules after outbound translation module 208 identifies values to assign to converted traffic.

The pools, ranges, or available values can also change on a condition. In an embodiment, the condition can be a length of time (e.g., change every 15 minutes). In alternative or complementary embodiments, these values can change based on an event, such as traffic suggestive of an attack. In still further alternative or complementary embodiments, these values can change on demand based on administrator activity or the activity of another entity.

In an example of use for traffic management module 200, a set of customers using a carrier's recursive DNS servers can include its mobility customers, business customers, and other internal corporate systems. Based on this employment, legitimate traffic from other carrier networks seeking to interact with the recursive DNS servers of the carrier will be traffic responsive to DNS queries sent by those recursive DNS systems, either based on customer requests or carrier-internal function. Because incoming traffic should correspond to outgoing traffic originating with the carrier and/or its customers, any other traffic destined for the carrier's recursive DNS servers may be dropped, as non-corresponding traffic is likely attack traffic or a result of erroneous policies of other carriers.

In embodiments, traffic management module 200 can drop traffic at peripheral elements of the carrier network, such as network gateways 122, 124, and 126, where traffic enters the network. In accordance with the disclosures herein, network gateways 122, 124, 126, et cetera, can include traffic tracking functionality to ensure incoming traffic corresponds to previously-sent traffic.

In such embodiments, the original source is recorded (e.g., using logging module 202) and/or mapped (e.g., based on translation modules described herein) and incoming traffic is matched to the recorded source to ensure it should be transmitted rather than dropped. The source can include IP address, port number, and/or other aspects for identifying transmission sources and destinations, as well as, protocol-specific markers such as the TCP initial sequence number or application-specific markers such as DNS transaction IDs as long as the responses also contain the same marker value.

In embodiments, a source IP Network Address Translation/Port Address Translation (NAT/PAT) function can be included at network gateways 122, 124, 126, et cetera, for tracking of outbound traffic originated by the carrier's recursive DNS servers (or other servers) and screening of inbound traffic destined for the carrier's recursive DNS servers (or other servers). In embodiments, traffic management module 200 can be on or available to network gateways 122, 124, 126, et cetera, or a supporting or complementary element such as the IP NAT/PAT function can be embodied on or available to the same in conjunction with a remote or distributed traffic management module 200. The NAT/PAT function can be provided by or included in the functionality of one or both of outbound translation module 208 and inbound translation module 210. In such embodiments, mapped outbound DNS queries are associated with a (converted) IP address and/or (converted) port number, and as such return traffic should be sent to that same combination which can be provided to the correct DNS server based on the mapping. The mappings are retained in a state table for reversal after a new entry is created based on outbound queries.

The result of embodiments such as those disclosed is a filtering technique whereby any attack traffic must match the correct IP address and UDP port number in order to reach the intended target. This greatly diminishes the attacker's ability to reach the carrier's recursive DNS server since the port number can be assigned randomly, which can vary in ranges such as, e.g., 1025-65535 for NAT/PAT translations. Further, in embodiments with NAT/PAT functionality, NAT/PAT pools can be employed, and such pools can be periodically changed (e.g., on-event, such as due to a traffic spike, or scheduled, such as every 30 seconds or every 15 minutes). The NAT/PAT pools can be coordinated by, e.g., orchestration module 212. Cloud orchestration of pool changing renders a wide variety of DNS attacks ineffective as attackers lacking internal knowledge would unlikely be able to “keep up” with the changes.

In embodiments, NAT/PAT functionality can be implemented on a software-defined network (SDN) enabled cloud infrastructure. Virtual machines or containers in this environment could be used exclusively for one function such as logging, mapping, NAT/PAT, et cetera, or multiple functions such as one or more of the foregoing in addition to network gateway routing functionality. Virtual machines or containers for one or more such capability can be added or removed as needed (e.g., on condition or scheduled based on utilization patterns) to an environment as needed at one or more gateways or other components as needed to handle traffic or other requirements.

In embodiments, an access control list (ad) can be associated with traffic management module 200, and elements thereof, such as logging module 202, outbound translation module 208 and inbound translation module 210, or otherwise implemented on various network elements. The access control list can block direct access by other external carrier networks to recursive DNS servers (or other servers).

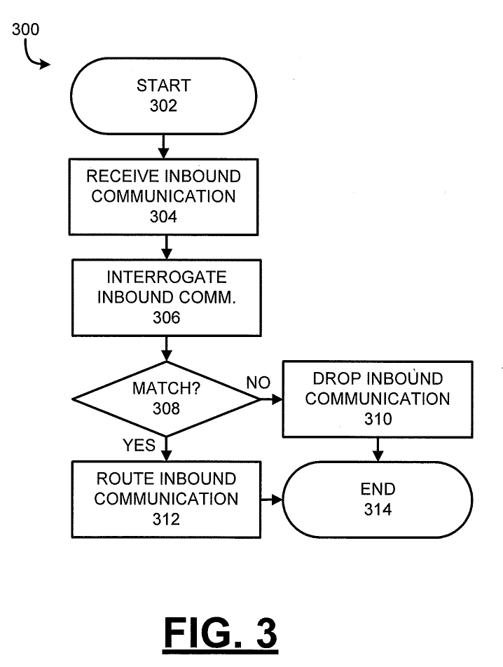

FIG. 3 illustrates an example methodology 300 for preventing or mitigating DDoS attacks. Methodology 300 begins at 302 and proceeds to 304 where an inbound communication is received. The inbound communication can be received at an internet gateway router or similar gateway and addressed to a downstream recursive DNS server or similar server. In at least one embodiment, preceding steps can include receiving and/or transmitting an outbound communication and logging information related thereto into a state table. In such embodiments, a further preceding step can include converting and mapping the outbound traffic information before or after logging traffic information (e.g., using NAT/PAT or other techniques).

At 306, the inbound communication is interrogated to determine at least its addressing information. In embodiments, other information such as header information can be received. In some embodiments, a mapping table or function such as a bloom filter can be leveraged, or addressing information converted, before methodology 300 proceeds.

At 308, a determination is made as to whether the addressing information (or information derived therefrom) is reflected in a traffic state table (e.g., of the gateway conveying the communications). If the addressing information for the inbound communication matches an entry in the traffic state table, indicating it corresponds to legitimate traffic, methodology 300 proceeds to 312 where the inbound traffic communication is routed to the appropriate element, which can be a server such as a recursive DNS server. If the determination at 308 returns in the negative, methodology 300 proceeds to 310 where the inbound communication is dropped. In either case, methodology 300 may then recycle to 304 if traffic is ongoing, or ends at 314.

Various embodiments are described herein to provide examples but not exhaustive descriptions of the scope and spirit of the innovation. An embodiment of a system can include a server module sending a query to an entity in an external network. The query exits the home network, i.e. the network where the server module is located, via a gateway router module. The system may include a logging module. The logging module logs the value of a chosen field in the query packet into a state table in memory. The gateway router modules use routing protocols with external networks so that the response to the query is guaranteed to enter the home network via the same gateway router module via which the query exited. The system can further include a monitor module. When a response is received at a gateway router module a monitor module consults the state table to match the value of the chosen field in the response packet. The system may also include a filter module. When the monitor module finds a match in the state table for the received response packet, the filter module allows the response to reach the server module which originated the query and the corresponding entry in the state table is removed. If a match is not found, the filter module drops the response packet.

In another embodiment, two or more values of two or more fields in the query packet may be combined and logged in the state table by the logging module. In this case, the monitor module combines the same fields in the received response to check for a matching entry in the state table. When a match is found the filter module allows the response packet to proceed to the server and the corresponding entry is removed from the state table. When a match is not found the response packet is dropped by the filter module.

In still another embodiment, a system can include a means for logging values of fields using a bloom filter (see, e.g., Bloom Filter Description) and monitoring and filtering the received response based on the bloom filter. In such an embodiment the bloom filter is equivalent to the state table.

In yet another embodiment, the system may include a translation module. The translation module may be used to change the value of one or more fields of the query packet before transmitting it. The translation module maintains a translation table which plays the role of the state table. When a response is received the translation table is used to match and translate back to the original values when there is a match. After a match is found and a translation is performed the corresponding entry is removed from the translation table. The filtering module drops the response packet when there is no matching entry in the translation table. Translation of both inbound and outbound traffic or traffic information may be performed by a single module, by separate modules dedicated to inbound traffic and outbound traffic, or in alternative arrangements.

In another embodiment, the system may contain an orchestration module and a translation module. The translation module may use a dynamic pool of values to change the value of one or more fields of the query packet before transmitting it. The pool of values may be changed periodically by an orchestration module.

In still another embodiment, one or more of the logging module, monitor module, translation module, filter module, and gateway router module may be combined into a single module.

In yet another embodiment, one or more of the logging module, monitor module, translation module, filter module, and gateway router module may be combined and implemented by employing cloud service chaining.

The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes an device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language, and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an device for implementing telecommunications as described herein. When implemented on a general-purpose processor, the program code combines with the processor to provide a unique device that operates to invoke the functionality of a telecommunications system.

What is claimed is:

1. A network gateway configured to receive one or more communications associated with a server, comprising:
a logging module configured to log outbound communication from the server in a traffic state table; and
a traffic interrogation module configured to interrogate at least one inbound communication for the server against the traffic state table,
wherein if the inbound communication corresponds to at least one entry in the traffic state table, the network gateway is configured to transmit the inbound communication to the server and remove the entry from the traffic state table, and
if the inbound communication does not correspond to the at least one entry in the traffic state table for the outbound communication, the network gateway is configured to prevent the inbound communication from reaching the server.

2. The network gateway of claim 1, the network gateway is an internet gateway router.

3. The network gateway of claim 1, the server is a Domain Name System (DNS) server.

4. The network gateway of claim 1, the server is a recursive DNS server.

5. The network gateway of claim 1, further comprising:
an outbound translation module configured to convert outbound traffic addressing of the outbound communication to converted traffic addressing, the converted traffic addressing included in the traffic state table; and
an inbound translation module configured to convert inbound traffic addressing of the inbound communication to correspond to the outbound traffic addressing for routing,
wherein the traffic interrogation module compares the inbound traffic addressing to the converted traffic addressing in the traffic state table.

6. The network gateway of claim 5, wherein the outbound translation module is configured to translate at least one of an internet protocol address and a port number of the outbound traffic addressing.

7. The network gateway of claim 6, wherein the outbound translation module is configured to select the internet protocol address for the outbound traffic addressing and the port number for the outbound traffic addressing from an internet protocol address pool and a port number address pool.

8. The network gateway of claim 5, further comprising an orchestration module configured to assign outbound traffic addressing ranges for use by the outbound translation module that are distinct from those assigned to a second outbound translation module of a second orchestration module, the second orchestration module of a second network gateway.

9. A method, comprising:
receiving an inbound communication for a server at a network gateway; and
interrogating the inbound communication against a traffic state table at the network gateway,
wherein if the inbound communication corresponds to an entry in the traffic state table, the inbound communication is transmitted to the server and the entry is removed from the traffic state table, and
if the inbound communication does not correspond to the entry in the traffic state table, the inbound communication is dropped at the network gateway.

10. The method of claim 9, further comprising:
receiving an outbound communication from the server at the network gateway; and
creating the entry in the traffic state table, the entry based on the outbound communication.

11. The method of claim 10, further comprising:
translating outbound traffic addressing of the outbound communication to converted traffic addressing; and
logging the converted traffic addressing in the entry of the traffic state table.

12. The method of claim 11, further comprising:
translating inbound traffic addressing of the inbound communication to correspond to the outbound traffic addressing for routing in response to matching the inbound traffic addressing to the converted traffic addressing in the traffic state table during interrogating of the inbound communication.

13. The method of claim 12, further comprising assigning outbound traffic addressing ranges for translating the outbound traffic addressing, the outbound traffic addressing ranges are distinct from those assigned in association with a second network gateway.

14. The method of claim 13, further comprising changing the outbound traffic addressing ranges after a condition is satisfied.

15. The method of claim 11, wherein translating the outbound traffic addressing changes at least one of an internet protocol address and a port number of the outbound traffic addressing.

16. The method of claim 15, further comprising selecting the internet protocol address for the outbound traffic addressing and the port number for the outbound traffic addressing from an internet protocol address pool and a port number address pool.

17. The method of claim 9, the network gateway is an internet gateway router.

18. The method of claim 9, the server is a recursive Domain Name System (DNS) server.

19. A system, comprising:
means for creating an entry in a traffic state table based on an outbound communication from a server; and
means for interrogating an inbound communication for the server at a network gateway, the inbound communication interrogated against the traffic state table,
wherein if the inbound communication corresponds to an entry in the traffic state table, the inbound communication is transmitted to the server and the entry is removed from the traffic state table, and
if the inbound communication does not correspond to the entry in the traffic state table for the outbound communication, the inbound communication is dropped at the network gateway.

20. The system of claim 19, further comprising:
means for translating outbound traffic addressing of the outbound communication to converted traffic addressing;
means for logging the converted traffic addressing in the entry of the traffic state table; and
means for translating inbound traffic addressing of the inbound communication to correspond to the outbound traffic addressing for routing in response to matching the inbound traffic addressing to the converted traffic addressing in the traffic state table.
